(19) United States
(12) Patent Application Publication
(10) Pub. No.: US 2005/0288144 A1
(43) Pub. Date: Dec. 29, 2005

(54) Preload limited-slip differential

(76) Inventors: Xiaochun Wang, Xi'an City (CN); Hong Jiang, Xi'an City (CN)

Correspondence Address: Peter B. Martine;MARTINE & PENILLA, LLP, Suite 200, 710 Lakeway Drive, Sunnyvale, CA, 94085, US

(21) Appl. No.: 11/040,149

(22) Filed: Jan. 20, 2005

Related U.S. Application Data
(63) Continuation-in-part of application No. PCT/CN04/00701, filed on Jun. 28, 2004.

(51) Int. Cl. F16H 48/30

(52) U.S. Cl. 475/221

(57) ABSTRACT

This invention relates to a type of preload limited-slip differential, by means of the friction between the back cone (51) of the side gear (5) and the friction ring (8) to realize the preload function of the differential, thus the length of the differential is not increased, the structure is very compact. Moreover, the gear ratio between the pinions (4) and side gears (5) periodically fluctuates to ensure higher one-wheel traction and lower turning resistance, and the contradictory requirements of good cross-country ability and steering agility are well balanced.

### FIELD OF THE INVENTION

This invention relates to a kind of limited-slip differentials for wheeled vehicles, particularly relates to a type of preload limited-slip differential.

### BACKGROUND OF RELATED ART

Limited-slip differentials are well known and take different forms, however, from the view point of the function, except for electronically controlled anti-slip breaking system, the limited-slip differentials can be divided into three basic models: overdrive, preload and torque proportioning ones.

For overdrive model, when one side of the driving wheels slips, all the input torque is transferred to none-slip driving wheel, having the best off-road ability. However, during the turning process on good road surface, all the input torque will be shifted to inner driving wheel, generating an anti-turning torque. To realize the overdrive function, there are two models: jar clutch and friction self-locking differentials. Among which the jar clutch differential works roughly, generates higher impact and noise during operation, may fail in a just on time change from locking condition into overdrive condition when running at a high speed, leading to hidden safety troubles.

For preload limited-slip differentials, there are two torque bias sources between both driving wheels: the first is the friction torque caused by preload springs, which has nothing to do with the input torque of the axle; the second is the additional friction torque caused by the axial thrust of the side gears on frictional pairs, being basically proportional to the input torque of the axle. Without special structure, the second part is generally rather small, thus the torque bias ability is mainly depending on the friction torque caused by preload springs. By means of applying larger preload friction torque, the driving axle can still generate higher traction even if one of the driving wheel is off the ground. However, for a fractionally loaded vehicle, the axle input torque may be even less than the preload friction torque, when the vehicle turns, the outer driving wheel will generate negative traction, greatly reduce the turning performance, increasing tyre wear and fuel consumption. In order to obtain required friction torque between the side gears and differential case, a number of alternatively arranged friction plates with inner and outer splines respectively connected to side gears and the differential case are used in the structure. This structure will not only increase the longitudinal size of the differential, but also greatly increase the cost because the material of the friction plates is rather expansive, and much more working processes must be carried out on the side gears and differential case.

Torque proportioning limited-slip differentials are not preloaded, using two methods to realize limited-slip function: one using the applied force on the transmission members to generate friction torque, thus the difference in the output torque of the differential is basically proportioning to the input torque of the axle. There are two generally used structures which can realize the principle: one using a structure having both inner and outer differential cases, and the inner case is composed by two half inner cases apart from each other, located inside the outer case and connected to the outer case by splines, being able to move along the axis of the outer case. The outer case transmits the input torque to the inner half cases through the splines, and the inner half cases transmit the torque to the cross by V-grooves cut in the end plane. Because of the function of the V-groove generating component forces, the normal pressure caused by the cross on V-groove surface will generate a proportional axial component on the inner case. Since the friction plates situate between the outer end surface of the inner case and the inner bottom of the outer case, the normal pressure applied to the friction plates is proportional to the input torque of the differential, thus the torque difference is basically proportional to the input torque. This kind of differentials have larger radial and longitudinal size, complicated structure and higher price. The other structure uses helical gears as differential gears, using the top lands and end surfaces as bearing and friction surfaces. Since the normal pressure on the friction surfaces is proportional to the input torque, the purpose that the torque difference is proportional to the input torque can also be realized. Since the abrasion resistant ability of the differential case is very high, the manufacturability is rather poor, the price is also high. The other method uses fluctuating gear-ratio bevel gears, using periodic change in gear ratio between the pinions and the side gears to obtain periodic torque proportioning with respect to the angle of rotation of the pinion. Especially after the applier of this patent having suggested three-pitch fluctuating transmission-ratio limited slip differential in prior patent WO 03/042583, the general slip limitation ability of fluctuating gear-ratio differentials reaches a rather higher level. These limited slip differentials can ensure that the traction of each driving wheel is positive when vehicles make turns, having nothing to do with the load of the vehicles. Therefore the turning resistance, tyre wear and fuel consumption are lower. However, if one side of the driving wheels is off the ground or on snow-icing road, the adhesive force is very small or equal to zero, the other driving wheel cannot obtain enough traction force to drive the vehicle.

Above all, each of the three basic models has some limitation in performance.

### SUMMARY OF THE INVENTION

The object of the present invention is to provide a type of preload limited-slip differential, the back cone of the side gears are utilized as one of the friction pair, thus the axial size is not increased, being compact in structure.

The object of the present invention is also to provide a type of preload limited-slip differential characterized by higher single-wheel traction and lower turning resistance, thus the cross-country and agile operation abilities can basically be fulfilled at the same time.

To realize the object, the technical scheme of the present invention is a type of preload limited-slip differential, at least involves a differential case with plural bevel pinions and a pair of bevel side gears situated within the case and composing a number of gear pairs, the characteristic is that each side gear has a back cone at the outer diameter, within the circumferential space between the back cone and differential case situates a friction ring, and the friction ring has an inner cone fitting with the back cone of the side gear, composing a friction pair. Some mechanism is used to stop the friction rings from relative rotation with respect to the case and transmit torque from the case to friction rings. Some elastic components are situated between the case and friction rings to keep the inner cone surface of the friction rings oppressing on the back cone of the side gears to generate required preload torque.

Thus under the axial thrust or pulling of the preload springs, the inner cone of the friction rings appress against the back cone of the side gears to generate normal pressure and friction torque being required to limit the relative rotation of the side gears with respect to the case. The reacting force of the normal pressure from the back cone applied on friction ring can be resolved into radial and axial components, among which the radical component changes into tensile stress in friction rings, while the axial component is balanced by preload springs. Because of the resolving function of cone surfaces and small cone angle being adopted for both back and inner cones, the required spring thrust can be much less than the sum of normal pressure applied on the friction pair surfaces. Therefore, the possibility of tooth flank damage caused by using over larger spring thrust can be avoided. Some mechanism such as spline or pin is used to stop the relative rotation of the friction ring with respect to the case, and springs are used to provide axial load on friction rings to ensure them oppressing on the back cone of the side gears. Because of the resolving function of cone surfaces, smaller axial thrust can be used to generate larger friction torque. Since the friction rings only occupy the circumferential space between the outer diameter of the side gear and differential case, the differential size is not increased, thus the structure is very compact.

Furthermore, during the process of the engagement between the pinion and side gears, the gear ratio fluctuates with a period of one or more pitches, and the number of pitches involved in each period are corresponding to the common factor in the number of teeth in both pinion and side gears. Each period of the gear ratio fluctuation involves a group of teeth, and the number of teeth involved in each group are corresponding to the number of pitches involved in each period, the combined working range of the teeth involved in each group covers the whole working range of both the pinions and side gears involved in a period of gear ratio fluctuation, and for each group of the same gear the corresponding teeth have the same structure.

Therefore, this invention makes the representative friction torque of one side gear with the friction ring on the other side gear be no longer a constant, but a periodic function of the angle of rotation of the pinions. When one of the driving wheels is off the ground, the reacting torque of the driving torque of the other driving wheel becomes the only driving moment to generate the differential motion, i.e. causing slip in the differential. This driving moment will not only overcome the friction torque between the side gear and the friction ring attached to the driving wheel with adhesive force, but also the representative friction torque between the side gear and the friction ring attached to the driving wheel off the ground, thus the driving torque of the driving wheel with adhesive force also becomes a periodic function of the angle of rotation of the pinions. The maximal value of the function is much larger than the average. If the required driving torque to move a vehicle is less than the maximum of above mentioned function, the differential will stop differential motion after the driving torque reaches the required driving torque to move the vehicle. Then both driving wheels and the differential case will rotate at a same speed as a rigid body, pulling the vehicle ahead. Since the gear pairs with fluctuating gear ratio have the ability to amplify the friction torque on the side gear attached to the driving wheel off the ground, the combination of the friction ring and gear pairs with fluctuating gear ratio can make both the maximal driving force for the situation of one of the driving wheel off the ground and the bias ratio of the driving torque distributed to the side gears be periodic functions of the angle of rotation of the pinions, which will obviously enhance the maximal traction for the situation of one driving wheel off the ground. For the situation of a vehicle turning an angle on normal road surface, the additional torque of each driving wheel needs only to overcome the friction torque between the attached side gear and the friction ring and the torque proportioning distribution caused by gear ratio fluctuation, needs not to overcome the representative friction torque of the other side gear with the friction ring. Therefore, in comparison with a torque proportioning differential without friction rings, also the average of turning resistance torque is increased, the amplitude of the fluctuation in turning resistance is reduced.

The better scheme for present invention is a small back cone angle between 6 to 20 degrees being adopted for the side gears, for using small back cone angle can ensure larger traction in one-wheel driving situation by means of utilizing smaller axial thrust, so that the possibility of the damage in tooth top fillet and surface and earlier wear can be avoided. However, if the back cone angle is less than 6 degrees, there exists the danger of self locking, should not be adopted. The friction rings axially move towards the side gears under the thrust of springs, appress the back cones of the side gears to generate required preload torque.

Practically, the mechanism to stop the relative rotation of the friction ring with respect to the case can be pins, key or spline, which are used to stop the relative rotation between the friction rings and the case, and transmit the torque from the case to friction rings.

For present invention, the practical pitches involved in each period of gear ratio fluctuation is 3, that means the numbers of tooth in both pinion and side gears are multiples of 3. In each group, three adjacent teeth are successively a lower tooth, a higher tooth and another lower tooth with the same tooth height of the above lower one. An other scheme is that in each group the adjacent three teeth are successively a higher tooth, a lower tooth and another higher tooth with the same tooth height of the above higher one.

For this invention, the pinions have an odd number of tooth groups, so that when the gear ratio between the pinions and one side gear reaches the maximum, the gear ratio between the pinion and the other side gear reaches the minimum. The group number in side gears is a multiple of the number of planet gears, so that each pinion works at the same phase angle.

The said gear ratio is a function as follows:

$$\frac{ⅆ {ϕ}^{( 1 )}}{ⅆ {ϕ}^{( 2 )}} = \frac{{z}_{2}}{{z}_{1}} [ 1 - C \cdot rat \cdot sin ( {z}_{2} {ϕ}^{( 2 )} / 3 ) + C \cdot ( 1 - rat ) \cdot sin ( {z}_{2} \cdot {ϕ}^{( 2 )} ) ]$$

where z₁ denotes the number of teeth in side gears, z₂ is the number of teeth in pinions, φ⁽¹⁾ represents the angle of rotation of the side gear, while φ⁽²⁾ indicates the angle of rotation of the pinions, C denotes the amplitude of gear ratio fluctuation, and rat expresses the ratio of the first order harmonic component of the gear ratio fluctuation in the sum of the first and third order harmonic components. The range of the number of teeth z₁ in side gears is 9, 12, 15 and 18; while the range of the numbers of teeth in pinions z₂ is 9 and 15; the codomain of C is 0.2 to 0.4; while the codomain of rat is 0.7 to 1.0.

Since the gear ratio is a function of the angle of rotation of the pinions φ⁽²⁾, the pitch angles of both the pinions and side gears are functions of the angle of rotation of the pinions φ⁽²⁾. The pitch angle of the side gears can be expressed as follows:

$${θ}^{( 1 )} = 90 ° - arctan \frac{ⅆ {ϕ}^{( 1 )}}{ⅆ {ϕ}^{( 2 )}}$$

while the pitch angle of the pinions is

$${θ}^{( 2 )} = arctan \frac{ⅆ {ϕ}^{( 1 )}}{ⅆ {ϕ}^{( 2 )}}$$

The expression of θ⁽²⁾ defines the pitch cone of the pinion in spherical coordinate. The intersecting line of the pitch cone and each pinion tooth flank is called pitch line of each tooth flank. The pitch line divides each pinion tooth flank into two parts, the tooth surface with the cone angle larger than pitch angle is named as upper tooth flank, while the tooth surface with the cone angle less the pitch angle is called lower tooth surface. The angle of rotation of the side gear can be expressed as:

$${ϕ}^{( 1 )} = \frac{{z}_{2}}{{z}_{1}} [ {ϕ}^{( 2 )} + \frac{3}{{z}_{2}} \cdot C \cdot rat \cdot cos ( {z}_{2} \cdot {ϕ}^{( 2 )} / 3 ) - \frac{1}{{z}_{2}} \cdot C \cdot ( 1 - rat ) \cdot cos ( {z}_{2} \cdot {ϕ}^{( 2 )} ) ]$$

Using both the expressions of φ⁽¹⁾ and φ⁽¹⁾ together defines the pitch cone of the side gear in spherical coordinate. The intersecting line of the pitch cone and each side gear tooth flank is called pitch line of each tooth flank. The pitch line divides each side gear tooth flank into two parts, the tooth surface with the cone angle larger than pitch angle is named as upper tooth flank, while the tooth surfaces with the cone angle less the pitch angle is called lower tooth surface.

The lower part of the profiles of the bevel gear pair with fluctuating gear ratio is some analytic curve, while the upper part is a conjugate profile of the analytic curve profile of the tooth that matches with, which is determined point by point based on the theorem of engagement that the relative speed between the tooth surfaces is perpendicular to the normal of the analytic tooth profile at the point. When the conjugate profile is in contact with the analytic profile, the relative movement between the gear pair can meet the equation as follows:

$$\frac{ⅆ {ϕ}^{( 1 )}}{ⅆ {ϕ}^{( 2 )}} = \frac{{z}_{2}}{{z}_{1}} [ 1 - C \cdot rat \cdot sin ( {z}_{2} {ϕ}^{( 2 )} / 3 ) + C \cdot ( 1 - rat ) \cdot sin ( {z}_{2} \cdot {ϕ}^{( 2 )} ) ]$$

where z₁ denotes the number of teeth in side gears, z₂ is the number of teeth in pinions, φ⁽¹⁾ represents the angle of rotation of the side gear, while φ⁽²⁾ indicates the angle of rotation of the pinions, C denotes the amplitude of gear ratio fluctuation, and rat expresses the ratio of the first order harmonic component of the gear ratio fluctuation in the sum of the first and third order harmonic components. The codomain of C is 0.2 to 0.4; while the codomain of rat is 0.7 to 1.0.

The range of the number of teeth z, in side gears is 9, 12, 15 and 18; while the range of the numbers of teeth in pinions z₂ is 9 and 15;

The analytic curve is a combination of straight line, circular and elliptical arcs, involute, Archimedean and logarithmic spiral. During the design process, it should be ensured that all profiles are convex curves, each tooth has a suitable top land width and root width, and there exists a suitable overlap between adjacent tooth pairs. Since each pair of teeth in a group has an individual working range, each tooth in a group has its individual profile.

The effectuating principle of this invention is the combination of preload friction torque and gear pairs with fluctuated gear ratio, thus the contradiction between the requirements of both turning resistance and the one-wheel traction is solved to a better extent.

Since the pitches involved in a period of gear ratio fluctuation between the pinion and side gears is able to be increased to more than 2, the relative angular acceleration between the pinion and side gear is greatly reduced, thus the contradiction between the requirements of increasing the amplitude of gear-ratio fluctuation and improving contact strength between tooth surfaces for common torque proportioning differentials is obviously alleviated.

A better embodiment of this invention is a preload three-pitch fluctuating gear-ratio differential, the period of the fluctuation in gear ratio between the pinion and side gears is three pitches, therefore even if the maximum gear ratio between two side gears reaches 1:1.875, the relative curvature between the tooth surfaces is less than that of common involute bevel gear pairs.

Suppose the friction torque between each side gear and a friction ring is M, neglecting the friction torque between the other moving elements in the differential, the average turning resistance torque will be M. For the situation of one driving wheel off the ground, if the differential slips continuously, the driving torque on the wheel with adhesive force will fluctuate between (1+1.857)M and (1+1/1.857)M. Provided the required driving torque for the vehicle to drive out the pit is not larger than 2.857M, the differential will not slip continuously, and the vehicle will smoothly go through. If common bevel gears are used in preload differentials, the maximal driving torque for the situation of one wheel driving will be 2M and kept unchanged; for the situation of adopting one-pitch fluctuating gear-ratio gear pairs, the maximal driving torque can only be increased to 2.38M. Therefore this invention can greatly enhance the maximal driving torque for one-wheel-driving situation under the condition of the same turning resistance.

Moreover, according to present invention, preload mechanism can be added to a differential without increasing its length or volume, this advantage will not only be favorable to the miniaturization in driving axle design, but also make the modification and upgrade of now available driving axles easy to be carried out.

Above all, the preload method of this invention directly utilize the back cone of the side gears as the friction surface, being compact in structure, without increasing axial length. Furthermore, the gear ratio of the fluctuating gear-ratio gear pairs changes in a period of one or multiple pitches. If the gear ratio changes in a period of multiple pitches, larger amplitude of gear ratio fluctuation can be obtained under the condition of smaller relative angular acceleration and relative curvature between tooth surfaces, with which smaller friction torque can be used to achieve larger one-wheel driving force, and the contradictory requirements of good cross-country ability and steering agility are well balanced.

### DESCRIPTION OF DRAWINGS

FIG. 1 is a schematic section view of the differential according to present invention;

FIG. 2 is a schematic section view to show the method to stop the relative rotation of the friction ring with respect to the case;

FIG. 3 is the drawing to show the structure of the side gear of the present inventions;

FIG. 4 is the drawing to show the structure of the pinion of the present inventions;

### DESCRIPTION OF PREFERRED EMBODIMENT

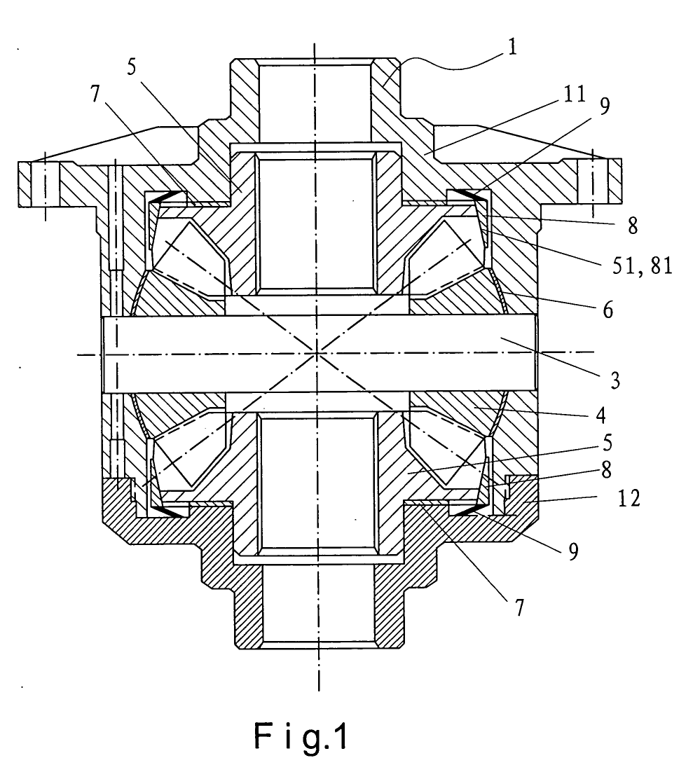

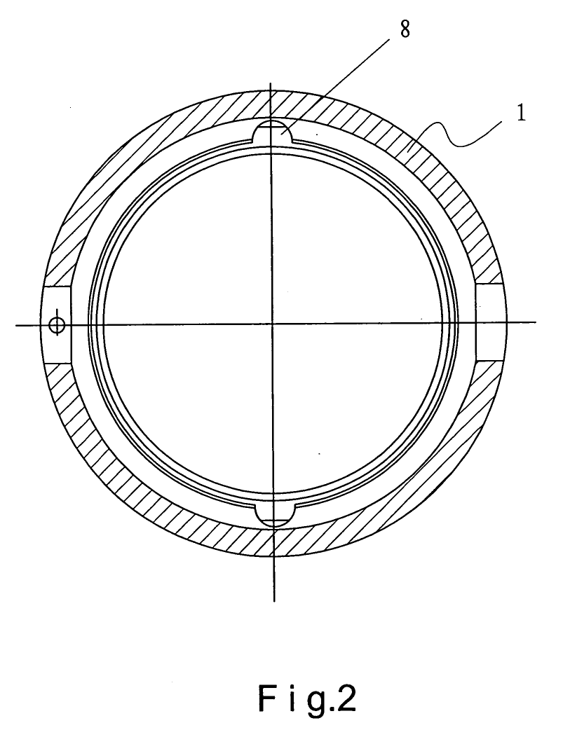

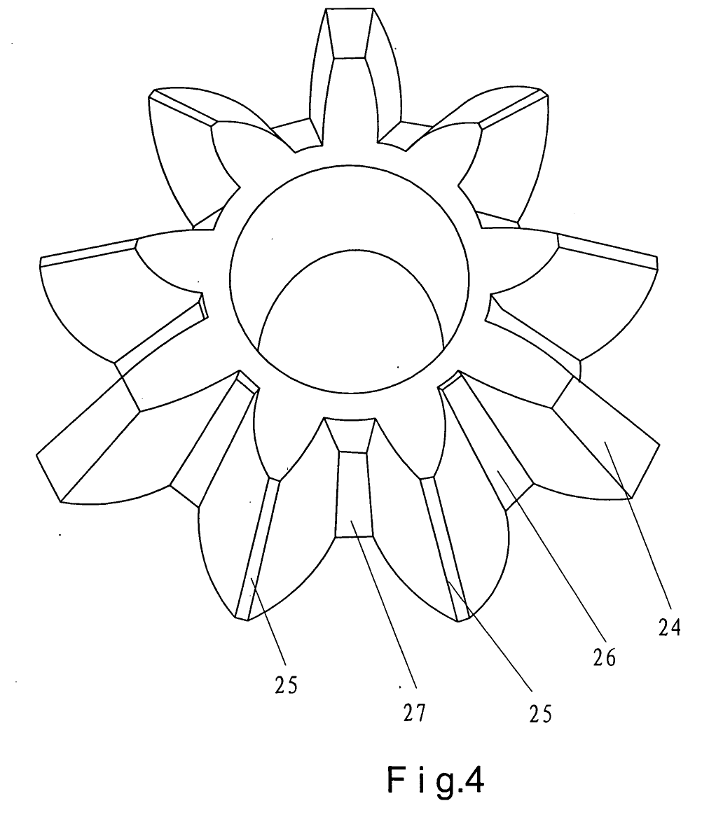

As illustrated in FIGS. 1 to 4, the preload limited-slip differential according to present involves at least a differential case 1 and plural gear pairs composed by planet pinions 4 and side gears 5 situated in differential case 1. The said side gears 5 have back cones 51 at the outer diameter, the friction rings 8 situates within the circumferential space between the back cone 51 and the differential case 1. The friction rings 8 have inner cones 81 which can fit with the back cones 51, composing friction pairs with back cones 51. Some mechanism is used to stop the said friction rings 8 from relative rotation with respect to the said differential case 1 and transmit torque from the said case 1 to friction rings 8. Some elastic components 9 are situated between the differential case 1 and friction rings 8 to keep the inner cone surface 81 of the friction rings 8 appressing on the back cone 51 of the side gears 5 to generate required preload torque.

Thus under the axial thrust or pulling of the preload elastic components 9, the inner cone 81 of the friction rings 8 appress against the back cone 51 of the side gears 5 to generate pressure and friction torque being required to limit the rotation of the side gears 5 with respect to the differential case 1. The reacting force of the normal pressure from the back cone 51 applied on friction ring 8 can be resolved into radial and axial components, among which the radical component changes into tensile stress in friction rings 8, while the axial component is balanced by preloading elastic elements 9. Because of the resolving function of cone surfaces, smaller axial thrust can be used to generate larger friction torque. Since the friction rings only occupy the circumferential space of the outer diameter of the side gear 5 and differential case 1, the differential size is not increased, thus the structure is very compact.

Furthermore, during the process of the engagement between the pinions 4 and side gears 5, the gear ratio between the pinion 4 and side gears 5 fluctuates with a period of one or multiple pitches, and the number of pitches involved in each period are corresponding to the common factor in the number of teeth in both pinion 4 and side gears 5. Each period of the gear ratio fluctuation involves a group of teeth, and the number of teeth involved in each group are corresponding to the number of pitches involved in each period, the combined working range of the teeth involved in each group covers the whole working range of both the pinions and side gears involved in a period of gear ratio fluctuation, and for each group of the same gear the corresponding teeth have the same structure.

For the embodiment, the said differential case 1 is practically composed by differential case body 11 and end cup 12, a cross or straight shaft 3 is situated in the differential case body 11 and end cap 12, spherical washers 6 situate between the pinions 4 and differential case body 11, and flat washers 7 are situated between the side gears 5 and differential case body 11 and end cap 12. The said pinions 4 and side gears 5 compose plural gear pairs. The mechanism to stop the relative rotation between the friction rings 8 and differential case 1 in present embodiment can be embodied as pin, key or spline.

According to present invention as illustrated in FIG. 1, the said fitting friction cone surfaces, i.e. the back cone 51 and inner cone 81 can be embodied as oblique cones, while the said preload elastic elements 9 can be embodied as preload springs. The said preload springs in this embodiment is embodied as pressure springs, one side of the spring acts on the outer end of the friction ring 8, while the other side acts on the differential case 1, as illustrated in FIG. 1. The said preload spring can also be embodied as tension springs, one side acts on the inner end of friction ring 8, while the other acts on the differential case I (this scheme is not illustrated).

For present invention, the inner cone surface 81 of the friction rings 8 and the back cone surface 51 of the side gears 5 have one and the same cone angle, the codomain of the cone angle can be further limited within 6 to 20 degrees. Because of the resolving function of cone surfaces and small cone angle being adopted for both back cones 51 and inner cones 81, the required spring thrust can be much less than the sum of normal pressure applied on the friction pair surfaces. Thus smaller axial thrust can be used to generate larger one-wheel driving force, and the possibility of tooth flank damage caused by using over large spring thrust can be avoided. For present embodiment, the back cone angle of the side gear is 12 degrees, therefore the normal pressure between the side gear 5 and friction ring 8 is 4.8 times of the thrust of preload springs 9. The number of teeth in the pinion 4 is 9, while the number of teeth in the side gear 5 is 12, both the numbers of teeth have a common factor of 3, so the number of pitches involved in each period of gear ratio fluctuation is 3. In each period of gear ratio fluctuation, a group of three adjacent teeth are involved, and each tooth has its special profile. Within a group of three teeth, each one has its individual working range, therefore the tooth height changes within the group, and each one has its individual profile.

For the same gear, the corresponding teeth in each group have the same profile and tooth height. The pinion gear 4 has 3 groups of teeth, thus when the gear ratio between the pinion gears 4 and one side gear 5 reaches the maximum, the gear ratio between the pinion gears 4 and the other side gear 5 gets the minimum, in this way a maximum torque bias ratio between two side gears can be obtained. The number of tooth groups in side gears 5 is 4, being a multiple of the number of pinion gears 4, so that each pinion gears 4 working at the same phase angle is ensured, thus the kinematical interference between the pinion gears 4 and side gears 5 is avoided.

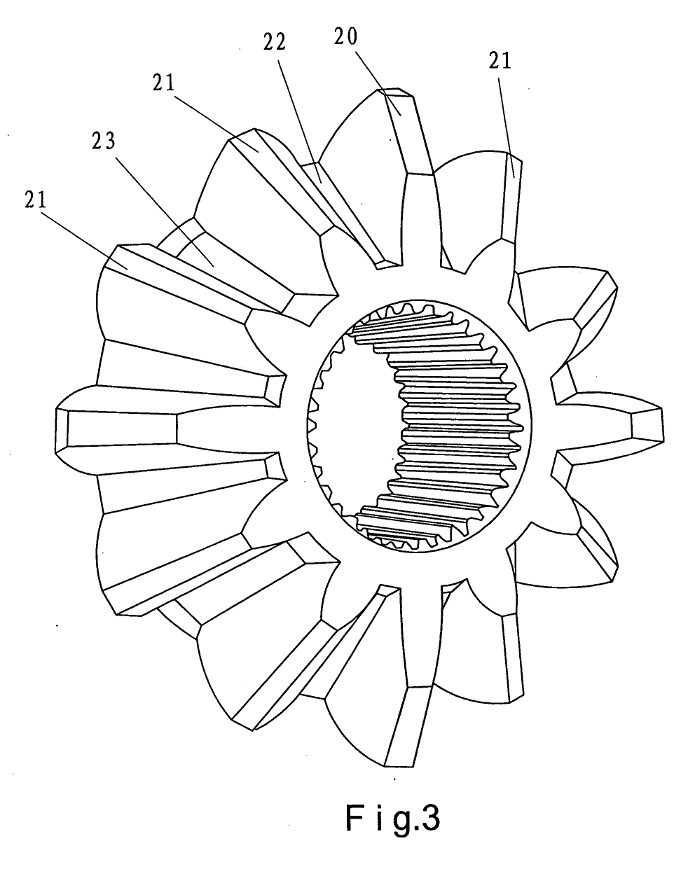

For present embodiment as illustrated in FIG. 3, in each group of three teeth are successively a lower tooth 21, a higher tooth 20 and another lower tooth 21 with the same tooth height of the above lower one. For side gears 5, between a higher tooth 20 and a lower tooth 21 is a shallower tooth groove 22, and between two lower teeth 21 is a deeper tooth groove 23. For pinion gears 4, between a higher tooth 24 and a lower tooth 25 is a shallower tooth groove 26, and between two lower teeth 25 is a deeper tooth groove 27.

The principle to realize the embodiment is that the back cone 51 of the side gears 5 is reduced to 12 degrees and used as friction surface, so that the effect for the preloading springs to generate one-wheel traction is improved. Meanwhile the period of gear ratio fluctuation is increased to three pitches, thus the number of speed ratio fluctuation in one revolution of the pinion 4 is reduced to one third in comparison with traditional design method, thus the speed ratio fluctuating range between two side gears 5 can be substantially increased while the relative angular acceleration between the pinions 4 and side gears 5 can be reduced at the same time. Therefore the one-wheel traction is increased while the turning resistance is kept unchanged, the object of the present invention is achieved.

The gear ratio of the gear pairs in present embodiment can be expressed as follows:

$$\frac{ⅆ {ϕ}^{( 1 )}}{ⅆ {ϕ}^{( 2 )}} = \frac{{z}_{2}}{{z}_{1}} [ 1 - C \cdot rat \cdot sin ( {z}_{2} {ϕ}^{( 2 )} / 3 ) + C \cdot ( 1 - rat ) \cdot sin ( {z}_{2} \cdot {ϕ}^{( 2 )} ) ]$$

where z₁ denotes the number of teeth in side gears, z₂ is the number of teeth in pinions, φ⁽¹⁾ represents the angle of rotation of the side gear, while φ⁽²⁾ indicates the angle of rotation of the pinions, C denotes the amplitude of gear ratio fluctuation, and rat expresses the ratio of the first order harmonic component of the gear ratio fluctuation in the sum of the first and third order harmonic components. For above gear pair the codomain of C is 0.2 to 0.4; while the codomain of rat is 0.7 to 1.0. The range of the number of teeth z₁ in side gears 5 is 9, 12, 15 and 18; while the range of the number of teeth z₂ in pinions 4 is 9 and 15; for practical embodiment, the number of teeth z₁ in side gears 5 is 12, while the number of teeth z₂ in pinions 4 is 9.

The profile design of this invention is based upon the given transmission ratio expression of the gear pairs. Having given the profiles of one member in the gear pair, the profiles of the other member can be determined point by point according to the theorem of engagement that the relative speed between the tooth surfaces is perpendicular to the normal of the given profile at the point. During the design process, it should be ensured that all profiles are convex curves, each tooth has a suitable top land width and root width, and there exists a suitable overlap of effect between adjacent tooth pairs. Since each tooth in a group has its individual working range in the period of gear ratio fluctuation, each tooth in a group of three teeth has its individual profile. The design method for present invention is described as follows: the lower part of the profile, i.e. beneath the pitch line is a simple analytic curve, which is a combination of straight line, circular and elliptical arcs, while the upper part, i,e. above the pitch line is a conjugate profile of the analytic curve profile of the tooth that matches with, which is determined point by point based on the theorem of engagement that the relative speed between the tooth surfaces is perpendicular to the normal of the analytic tooth profile at the point.

When the conjugate profile is in contact with the analytic profile, the relative movement between the gear pair can meet the equation as follows:

$$\frac{ⅆ {ϕ}^{( 1 )}}{ⅆ {ϕ}^{( 2 )}} = \frac{{z}_{2}}{{z}_{1}} [ 1 - C \cdot rat \cdot sin ( {z}_{2} {ϕ}^{( 2 )} / 3 ) + C \cdot ( 1 - rat ) \cdot sin ( {z}_{2} \cdot {ϕ}^{( 2 )} ) ]$$

where z₁ denotes the number of teeth in side gears 5, z₂ is the number of teeth in pinions 4, φ⁽¹⁾ represents the angle of rotation of the side gear, while φ⁽²⁾ indicates the angle of rotation of the pinions, C denotes the amplitude of gear ratio fluctuation, and rat expresses the ratio of the first order harmonic component of the gear ratio fluctuation in the sum of the first and third order harmonic components. The codomain of C is 0.2 to 0.4; while the codomain of rat is 0.7 to 1.0.

The range of the number of teeth z₁ in side gears is 9, 12, 15 and 18; while the range of the number of teeth in pinions z₂ is 9 and 15; for practical embodiment, the number of teeth z₁ in side gears 5 is 12, while the number of teeth z₂ in pinions 4 is 9.

For present embodiment, when the thrust of preload springs is adjusted to 1,000N, the maximal one-wheel driving torque can reach 90N-m, while the turning resistant torque (a pair of torque of the same amount and opposite direction applied on both driving wheels which can just cause differential motion in the differential assembly) is only 28N-m.

The parameters and experimental result presented above are used to demonstrate the invention, not used as a limitation to the invention.

1. A preload limited-slip differential comprising a differential case, a pair of side gears and plural pinions situated within the differential case and composing plural gear pairs having the characteristic that each side gear has a back cone at the outer diameter, within the circumferential space between the back cone and differential case situates a friction ring, and the friction ring has an inner cone fitting with the back cone of the side gear, composing a friction pair, wherein a mechanism is used to stop the friction rings from relative rotation with respect to the case and transmit torque from the case to friction rings, and elastic components are situated between the case and the friction rings to keep the inner cone surface of the friction rings appressing on the back cone of the side gears to generate required preload torque.

2. The preload differential according to claim 1, wherein the gear ratio between said pinions and said side gears fluctuates during the engagement process, and said gear ratio fluctuates with a period of one or plural pitches, and the number of said pitches involved in each said period is corresponding to the common factor in the number of teeth in said pinion and said side gears, therefore each said period of gear ratio fluctuation involves a group of teeth, and the number of teeth involved in each group are corresponding to the number of said pitches involved in each said period of gear ratio fluctuation, the combined working range of the teeth involved in each said group covers the whole working range involved in a said period of gear ratio fluctuation, and for each group of the same gear the corresponding teeth have the same structure.

3. The preload differential according to claim 1, wherein the said inner cone of the friction ring has the same cone angle of the back cone of said side gears, the codomain of the cone angle is from 6 to 20 degrees.

4. The preload differential according to claim 1, wherein the said mechanism to stop the friction rings from relative rotation with respect to the case is pin, key or spline.

5. The preload differential according to claim 1, wherein the said fitting friction surfaces are oblique cones.

6. The preload differential according to claim 1, wherein the said preload elastic elements are preload springs.

7. The preload differential according to claim 6, wherein the said preload spring is pressure spring, one side of the spring acts on the outer end of the friction ring, while the other side acts on the differential case; or the said preload springs are tension springs, one side of each spring acts on the inner end of the friction ring, while the other acts on the differential case.

8. The preload differential according to claim 2, wherein the working range for each pair of tooth in each said group can be determined in design process, and there is a small overlap in said working range between adjacent tooth pairs.

9. The preload differential according to claim 2, wherein both tooth numbers of said pinion and side gears are multiples of 3, during the process of engagement, said gear ratio fluctuates in a period of three pitches.

10. The preload differential according to claim 2, wherein said pinion has an odd group number, so that during the engagement process, when the gear ratio between said pinions and one said side gear reaches the maximum, the gear ratio between said pinions and other said side gear reaches the minimum.

11. The preload differential according to claim 2, wherein the group number in said side gears is a multiple of the number of said pinions, so that each said pinion works at the same phase angle.

12. The preload differential according to claim 9, wherein each said group comprises successively one lower tooth, a higher tooth and another lower tooth of the same height of said lower one, between said higher tooth and said lower tooth is a shallower tooth groove, and between two said lower teeth is a deeper tooth groove; or each said group comprises successively one higher tooth, a lower tooth and another higher tooth of the same height of said higher one; between said higher tooth and said lower tooth is a deeper tooth groove, and between two said higher teeth is a shallower tooth groove.

13. The preload differential according to claim 9, wherein said gear ratio between said gear pairs is a function as follows:
$$\frac{ⅆ {ϕ}^{( 1 )}}{ⅆ {ϕ}^{( 2 )}} = \frac{{z}_{2}}{{z}_{1}} [ 1 - ( C ( rat ) sin ( {z}_{2} {ϕ}^{( 2 )} / 3 ) ) + ( C ( 1 - rat ) sin ( {z}_{2} \cdot {ϕ}^{( 2 )} ) ) ]$$
where z₁ denotes the number of teeth in said side gears, z₂ is the number of teeth in said pinions, φ⁽¹⁾ represents the angle of rotation of said side gears, while φ⁽²⁾ indicates the angle of rotation of said pinions, C denotes the amplitude of gear ratio fluctuation, and rat expresses the ratio of the first order harmonic component of the gear ratio fluctuation in the sum of the first and third order harmonic components.

14. The preload differential according to claim 2, wherein the profiles of the lower part of said teeth in said pinions and said side gears beneath the pitch lines are analytic curves, while the upper part of said teeth are conjugate profiles of said analytic curve profiles of the teeth that match with, which is determined point by point based on the theorem of engagement that the relative speed between said tooth surfaces is perpendicular to the normal of said analytic tooth profiles at the point.

15. The preload differential according to claim 14, wherein when said conjugate profiles in contact with said analytic profiles of the matching teeth, said gear ratio meet the equation as follows:
$$\frac{ⅆ {ϕ}^{( 1 )}}{ⅆ {ϕ}^{( 2 )}} = \frac{{z}_{2}}{{z}_{1}} [ 1 - ( C ( rat ) sin ( {z}_{2} {ϕ}^{( 2 )} / 3 ) ) + ( C ( 1 - rat ) sin ( {z}_{2} \cdot {ϕ}^{( 2 )} ) ) ]$$
where z₁ denotes the number of teeth in said side gears, z₂ is the number of teeth in said pinions, φ⁽¹⁾ represents the angle of rotation of said side gears, while φ⁽²⁾ indicates the angle of rotation of said pinions, C denotes the amplitude of gear ratio fluctuation, and rat expresses the ratio of the first order harmonic component of the gear ratio fluctuation in the sum of the first and third order harmonic components.

16. The preload differential according to claim 13, wherein the codomain of C is from 0.2 to 0.4, the codomain of rat is from 0.7 to 1.0, the range of the number of teeth in said side gear z₁ is 9, 12, 15 and 18; and the corresponding range of the number of teeth in said pinion z₂ is 9 and 15.

17. The preload differential according to claim 2, wherein the inner cone of the friction ring has the same cone angle of the back cone of said side gears, the codomain of the cone angle is from 6 to 20 degrees.

18. The preload differential according to claim 15, wherein the codomain of C is from 0.2 to 0.4, the codomain of rat is from 0.7 to 1.0, the range of the number of teeth in said side gear z₁ is 9, 12, 15 and 18; and the corresponding range of the number of teeth in said pinion z₂ is 9 and 15.
